(19) United States
(12) Patent Application Publication
(10) Pub. No.: US 2004/0189900 A1
(43) Pub. Date: Sep. 30, 2004

(54) LCD panel

(76) Inventor: Wen Chen Yang, Panchiao City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/397,298

(22) Filed: Mar. 27, 2003

(51) Int. Cl. G02F 1/1335

(52) U.S. Cl. 349/114

(57) ABSTRACT

The present invention relates to an LCD panel, which includes at least two divided areas being possibly made of transparent structure, semitransparent structure, or reflective structure. By use of different characters of various structures, the panel can display a clear figure while it can save in use of electricity that obtains improvement.

### FIELD OF THE INVENTION

The present invention relates to an improved LCD panel, which is composed by at least two different structures for providing various functions.

### BACKGROUND OF THE INVENTION

A conventional LCD panel can be made as a transparent type, a semitransparent type, or a reflective type. By use of different character, the LCD can display various effects on the panel. For example, the panel being transparent shows a bright figure but is waste of electricity. A reflective panel is economic in using electricity, but it shows nothing in dark. It is known that all prior LCD panel is made by only one single structure. It can not provide a widely utility.

Accordingly, the primary object of the invention is to provide an improved LCD panel, which includes at least two structures to be assembled together. The panel is divided to at least two areas for providing various functions that meets utilized use of improvement.

### BRIEF DESCRIPTION OF ACCOMPANYING DRAWINGS

Now the features and advantages of the present invention will be described in detail with reference to the accompanying drawings.

FIG. 1 is a plan view showing an LCD panel having two structures according to the present invention.

FIG. 2 is a plan view showing an LCD panel having three structures according to the present invention.

FIG. 3 is a plan view showing another embodiment of the LCD panel according to the present invention.

FIG. 4 is a plan view showing a further modified embodiment of the LCD panel according to the present invention.

### DETAILED DESCRIPTION OF PREFERRED EMBODIMENTS

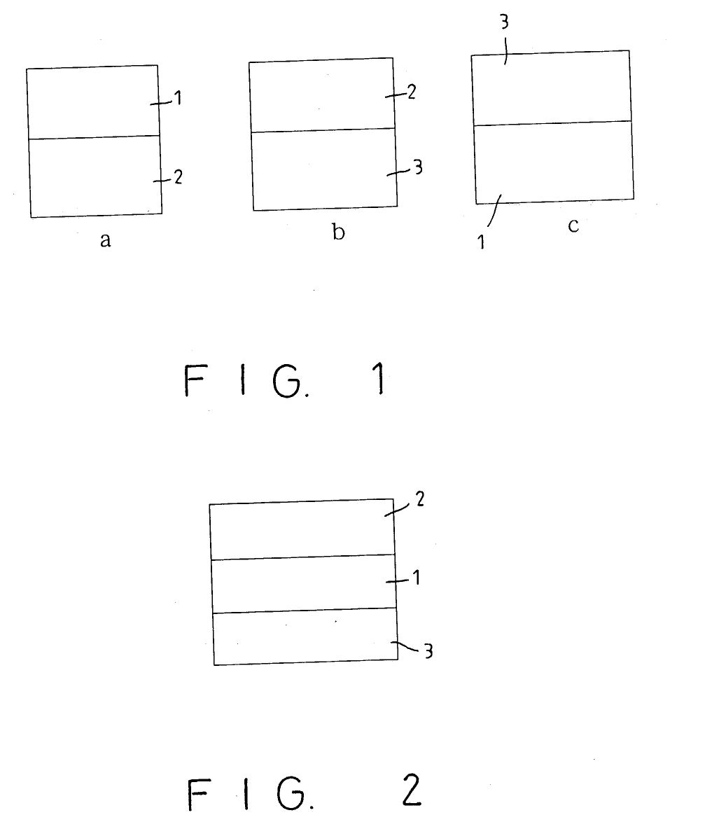

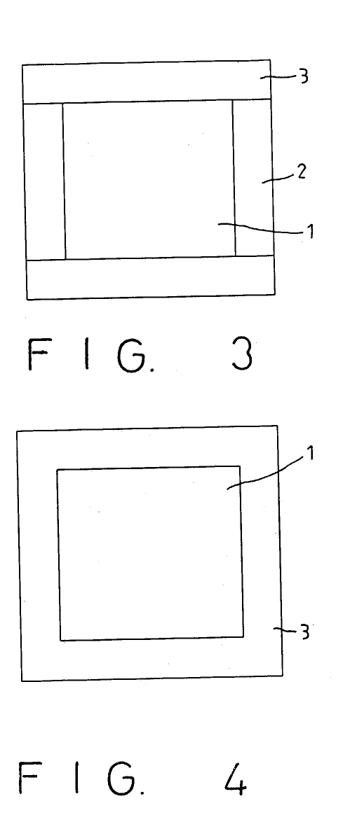

The present invention relates to an improvement for an LCD panel, which is made of at least two different structures including a transparent type, a semitransparent type, or a reflective type. As shown in FIG. 1 and 2, the characteristic of the present invention is to provide an LCD panel, which includes two divided areas. The structure of the panel can be a transparent type (1) together with a semitransparent type (2) in FIG. 1a, a semitransparent type (2) together with a reflective type (3) in FIG. 1b, or a reflective type (3) together with a transparent type (1) in FIG. 1c. The structure of the panel also can be divided into three areas including the transparent type (1), the semitransparent type (2), and the reflective type (3) in FIG. 2. Moreover, other modified embodiments being divided into various shapes are also claimed in this invention, such as shown in FIG. 3 and 4 and etc.

Since different structures have various characters, the present invention assembles these different functions that obtains a complete panel. In the LCD panel according to the present invention, it can improve the displaying quality. Such as to keep the main displaying area on the panel being made on a transparent structure that displays clear and bright figure, while the other areas being made of a semitransparent structure or a reflective structure that saves use of electricity. It can be found that the LCD panel according to the present invention obtains a perfect displaying effect.

What is claimed is:

1. An LCD panel including at least two different structures being parts of various divided areas and being assembled together.

2. The LCD panel as claimed in claim 1, wherein the different structures of the panel include transparent type, semitransparent type, or reflective type.

3. The LCD panel as claimed in claim 1, wherein the panel has main displaying divided area being made of transparent structure, and has other divided areas being made of semitransparent structure or reflective structure.
